(19) United States
(12) Patent Application Publication
(10) Pub. No.: US 2016/0217017 A1
(43) Pub. Date: Jul. 28, 2016

(54) DETERMINING WORKFLOW COMPLETION STATE

(71) Applicant: International Business Machines Corporation, Armonk, NY (US)

(72) Inventors: Meng Ding, Markham (CA); Zhi Hua Jin, Xi'an Shaanxi (CN); Qingda Wang, Richmond Hill (CA)

(21) Appl. No.: 14/828,547

(22) Filed: Aug. 18, 2015

Related U.S. Application Data
(63) Continuation of application No. 14/603,419, filed on Jan. 23, 2015.

(51) Int. Cl. G06F 9/52

(52) U.S. Cl. CPC G06F 9/52

(57) ABSTRACT

As disclosed herein a method, executed by a computer, for automatically determining a workflow completion state includes initiating a workflow including one or more jobs, receiving a notification that a first job corresponding to the workflow has finished, checking dependency requirements of a successor job corresponding to the first job, submitting the successor job for processing if the dependency requirements have been satisfied, and evaluating a completion status of each of the one or more jobs to determine whether the workflow is still running. Complex workflows may consist of many jobs, all of which may not be required to complete for the workflow to complete successfully. The method described herein enables the completion state of a workflow to be determined without requiring user defined completion criteria.

### STATEMENT REGARDING PRIOR DISCLOSURES BY THE INVENTOR OR A JOINT INVENTOR

The following disclosure(s) are submitted under 35 U.S.C. 102(b)(1)(A) as prior disclosures by, or on behalf of, a sole inventor of the present application or a joint inventor of the present application:

(1) IBM Platform LSF V9.1.3, IBM, August 1, 2014, http://www-01.ibm.com/common/ssi/ShowDoc.wss?docURL=/common/ssi/rep_oc/2/877/ENUS5725 -G82/index.html&lang=en&request_locale=en

### BACKGROUND OF THE INVENTION

The present invention relates generally to the field of workflow analysis, and more particularly to automatically determining a workflow completion state.

Historically, a workflow is an orchestrated and repeatable sequence of activities that are necessary to complete a task. For a workflow to successfully complete, workflow specific completion criteria are typically defined that must be satisfied. The completion criteria may include successful completion of at least some of the activities corresponding to the workflow.

### SUMMARY

As disclosed herein a method, executed by a computer, for automatically determining a workflow completion state includes initiating a workflow including one or more jobs, receiving a notification that a first job corresponding to the workflow has finished, checking dependency requirements of a successor job corresponding to the first job, submitting the successor job for processing if the dependency requirements have been satisfied, and evaluating a completion status of each of the one or more jobs to determine whether the workflow is still running. Complex workflows may consist of many jobs, all of which may not be required to complete for the workflow to complete successfully. The method described herein enables the completion state of a workflow to be determined without requiring user defined completion criteria.

### BRIEF DESCRIPTION OF THE SEVERAL VIEWS OF THE DRAWINGS

FIG. 1 is a functional block diagram of one embodiment of a data processing environment in which at least some of the embodiments disclosed herein may be deployed;

FIG. 2 is a flow chart depicting one embodiment of a job dependency analysis method, in accordance with an embodiment of the present invention;

FIG. 3 is a flow chart depicting one embodiment of a workflow analysis method, in accordance with an embodiment of the present invention; and

FIG. 4 is a block diagram depicting various components of one embodiment of a computer suitable for executing the methods disclosed herein, in accordance with an embodiment of the present invention.

### DETAILED DESCRIPTION

A workflow can be described as the series of activities that must be performed before a task consisting of those activities is complete. A workflow may consist of a simple activity, also known as a job, or a workflow may consist of numerous complex jobs, some of which may be conditionally performed, depending on the results of a prior job. Determining if a workflow has successfully completed may be a relatively simple task, if all jobs in the workflow are required to successfully complete prior to the workflow being considered complete. However, in the more complex scenarios, program or business logic may prohibit one or more jobs from running, and therefore, successful completion criteria may have to be defined, by an individual with knowledge of the overall workflow and underlying technology, prior to workflow execution. It has been determined that relying on individuals to define completion criteria can be error prone, resulting in workflows waiting for a job to complete that can never run (i.e., a workflow never completing) or workflows being erroneously considered successfully complete. The embodiments disclosed herein provide an automated method for accurately determining a workflow completion state.

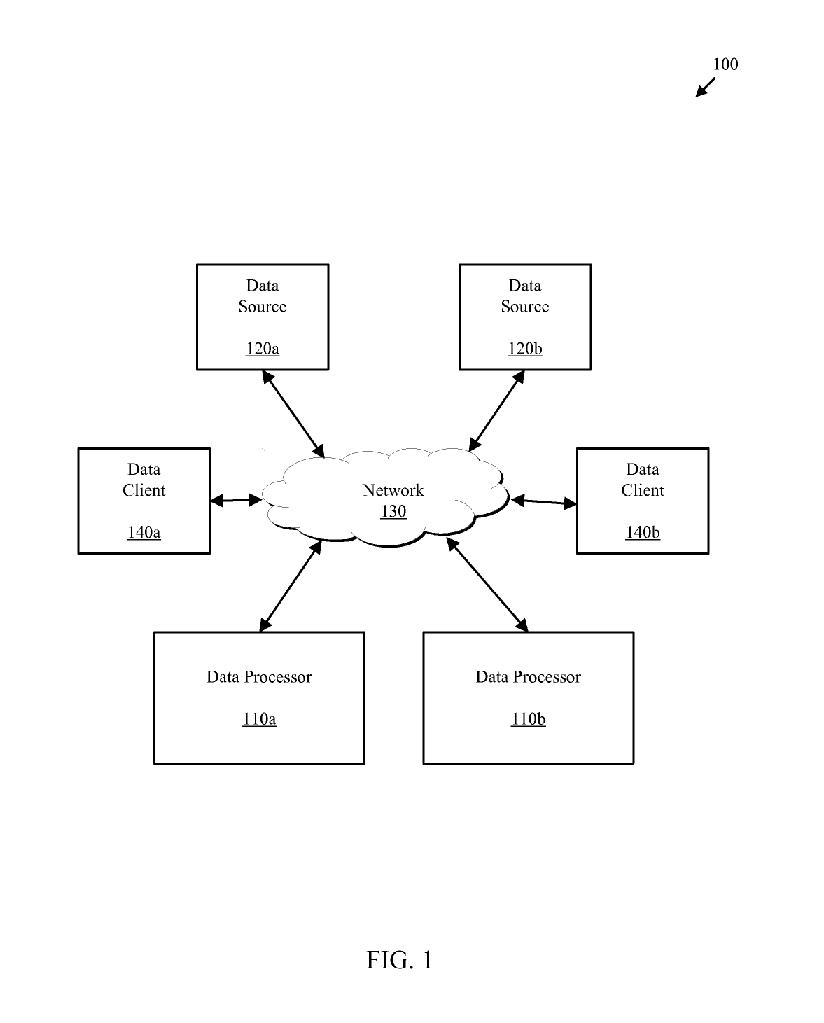

FIG. 1 is a functional block diagram of one embodiment of a data processing environment 100. As depicted, the data processing environment 100 includes one or more data processors 110 (e.g., data processors 110a and 110b), one or more data sources 120 (e.g., data sources 120a and 120b), a network 130, and one or more data clients 140 (e.g., data clients 140a and 140b). The data processing environment 100 is one example of an environment in which at least some of the embodiments disclosed herein may be deployed.

The data processors 110 may initiate and monitor workflows consisting of one or more jobs. The data processors 110 may also process jobs using data provided by, or retrieved from, the data sources 120. The data sources 120 may be accessible to the data processors 110 via the network 130. One or more data clients 140 may also be connected to the data processors 110 via the network 130. In some embodiments, the data processor 110a processes jobs associated with a workflow being monitored by data processor 110b. In some embodiments, the data clients 140 process jobs associated with the workflow being monitored by data processors 110. In other embodiments the data sources 120 are also data clients 140.

Data accessible by the data sources 120 may be data in a database, spreadsheet, flat file, or any other source of data. The data may be stored on a mass storage device; for example, hard disk drives, magnetic tape drives, optical disc drives, or solid-state drives. In some embodiments, the data is readily available to the data processors 110 and the data clients 140. In other embodiments, the data is retrieved or written while jobs are being processed by the data processors 110 or the data clients 140.

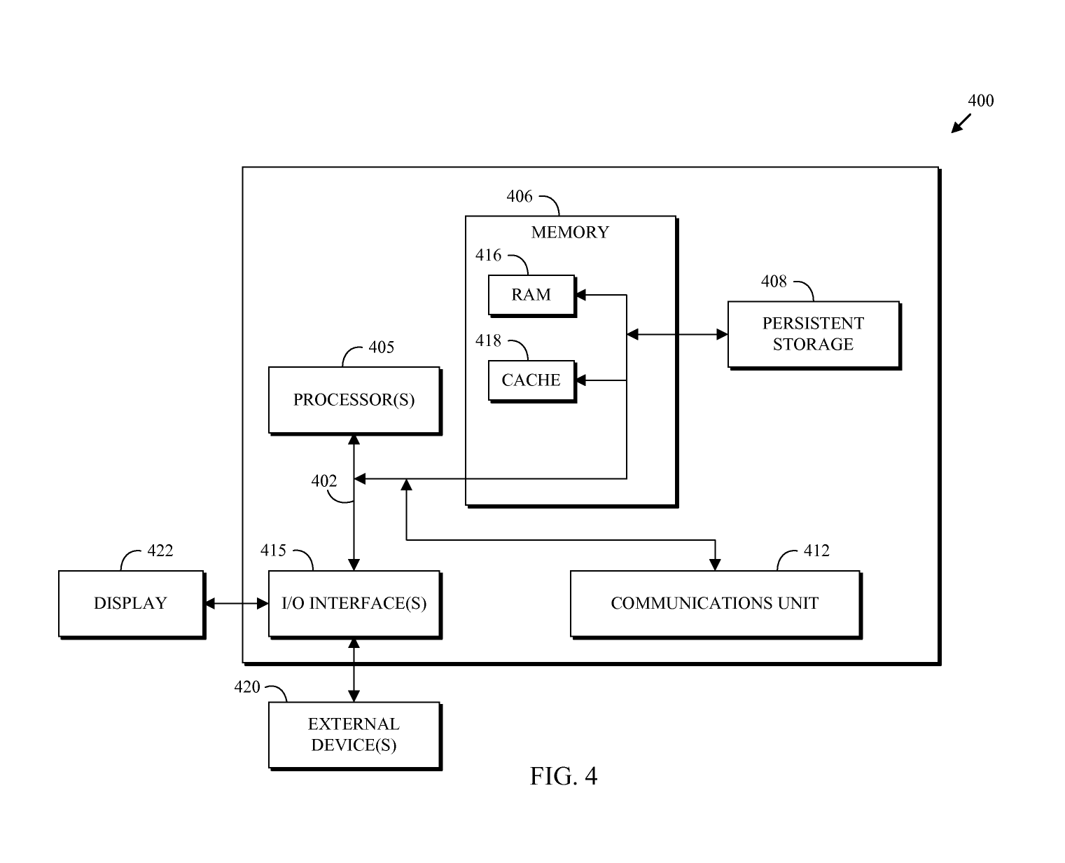

It should be noted that the data processors 110 may include internal and external hardware components, as depicted and described in further detail with respect to FIG. 4. Furthermore, the network 130 can be any combination of connections and protocols that will support communications between the data processors 110, the data sources 120, and the data clients (i.e., data consumers) 140. For example, the network 130 can be a local area network (LAN), a wide area network (WAN) such as the Internet, or a combination of the two, and can include wired, wireless, or fiber optic connections.

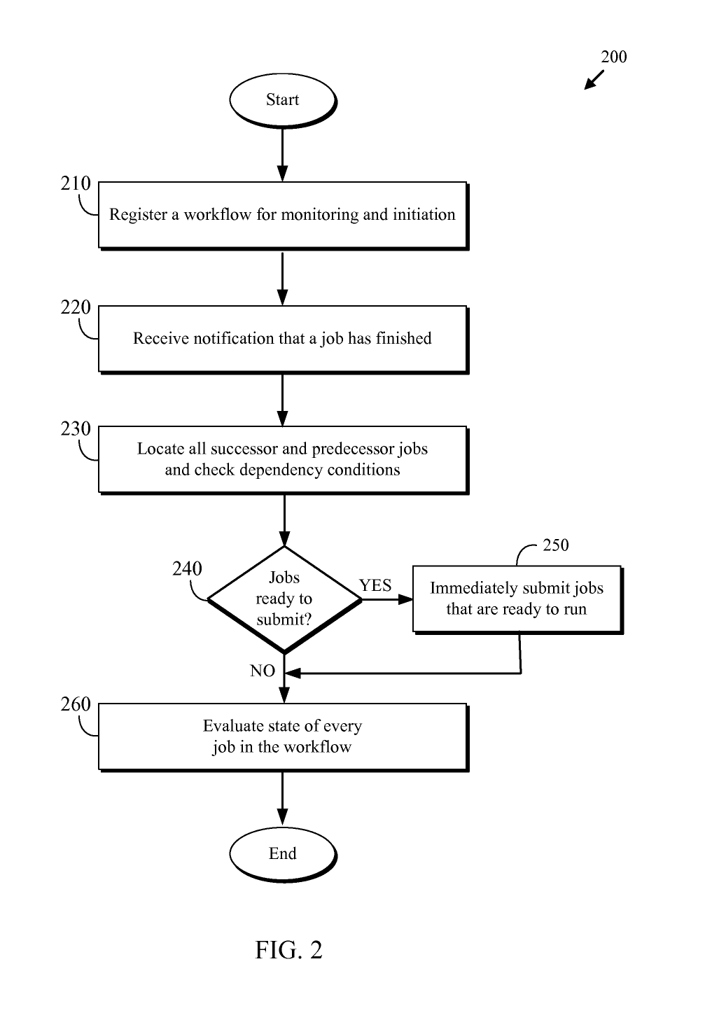

FIG. 2 is a flow chart depicting one embodiment of a job dependency analysis method 200. As depicted, the job dependency analysis method 200 includes registering (210) a workflow for monitoring and initiation, receiving (220) notification that a job has finished processing, locating (230) all successor and predecessor jobs, determining (240) whether any jobs are ready to submit, submitting (250) jobs that are ready to run, and evaluating (260) the state of the workflow. The job dependency analysis method 200 enables immediate submission of jobs if the dependency conditions of the job have been satisfied.

Registering (210) a workflow for monitoring and initiation may include performing an initial analysis of jobs corresponding to the workflow. To facilitate successful monitoring of the workflow, population of data structures containing lists of all jobs available to the workflow may be utilized. Additionally, for each job in the lists, additional information may be collected, which may include successor jobs and predecessor jobs as well as dependency conditions for each job. The workflow may be initiated, and jobs with no dependencies as well as any jobs whose dependencies have been satisfied may be submitted. In some embodiments, the jobs are run on the same computer as the monitoring process. In other embodiments, the jobs are run on other computers that are accessible through a network.

Receiving (220) notification that a job has finished processing may include receiving notification that a job, corresponding to the workflow, has successfully run to completion. In some embodiments, the data structures corresponding to the workflow are updated with a status indicator that identifies the current state of the job. The status indicator may be a collection of bits representing possible job states. Alternatively, the status indicator may be a string field containing an indication of the job state.

Receiving (220) notification that a job has finished processing may also include receiving notification that a job has completed processing unsuccessfully. In some embodiments, a job indicates completion by exiting with a completion code, where the completion code may be zero, a positive value, or a negative value. In other embodiments, a zero completion code indicates a successful completion while a non-zero completion code indicates an unsuccessful completion. In another embodiment, job completion is indicated by an event that triggers a signal, notifying the monitor of the job completion.

Locating (230) all successor and predecessor jobs may include cycling through the data structures of successor and predecessor jobs corresponding to the workflow, and checking dependency requirements for each job to determine if the dependency conditions for a job have been satisfied. In some embodiments, verifying dependency fulfillment occurs for each job identified in the data structures corresponding to the workflow. In other embodiments, verifying dependency fulfillment only occurs for jobs that have not been submitted for execution. In one embodiment, each job whose dependency conditions have been satisfied is immediately submitted for processing. In another embodiment, a list is identified containing jobs that are ready to run, and the list is processed as soon as all jobs have been verified.

Determining (240) whether any jobs are ready to submit may include verifying if the locate procedure 230 identified any jobs that are ready to submit. If there are jobs ready to submit, the method 200 proceeds to the submit jobs 250 operation. Otherwise, the method proceeds to the evaluating operation 260.

Submitting (250) jobs that are ready to run may include immediately initiating each job whose dependency conditions have been satisfied. In some embodiments, a job is submitted for execution as soon as the locate procedure 230 has determined the dependencies of the job have been fulfilled. In other embodiments, jobs ready to submit are identified in a list and submitted for execution as soon as the locate procedure 230 is complete. In another embodiment, the status indicator of the data structures corresponding to the workflow is updated to indicate the current state of the job.

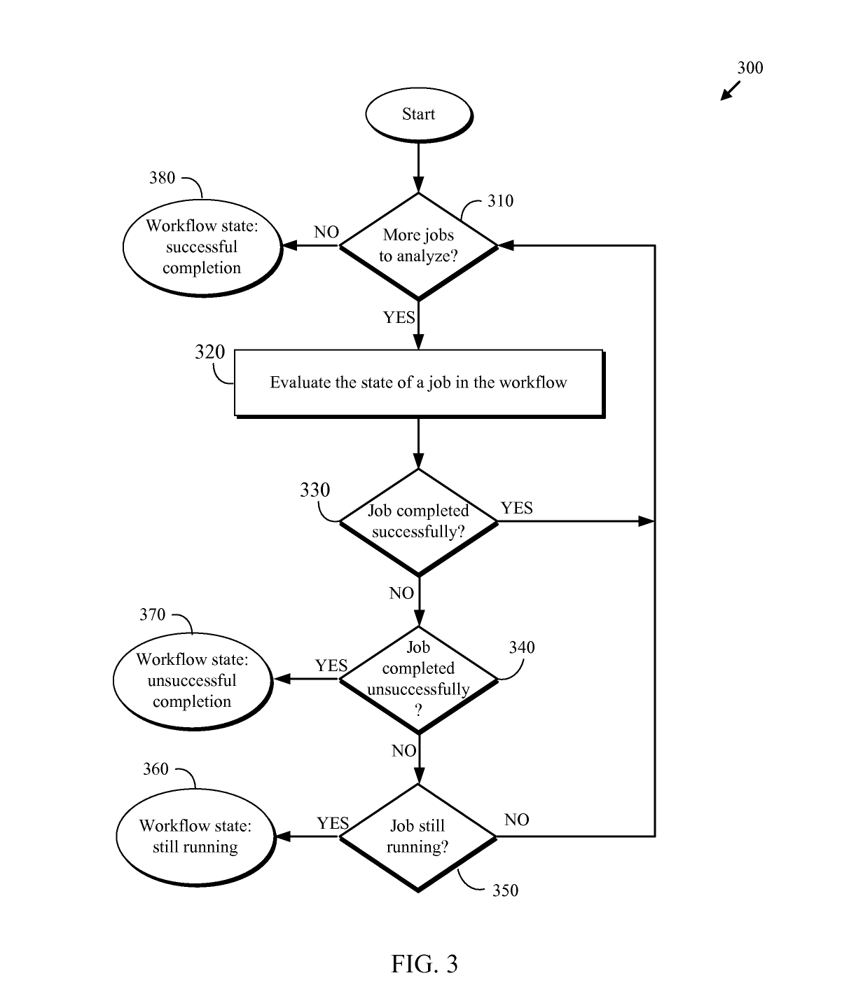

Evaluating (260) the state of every job in the workflow may include examining the current state of each job in the workflow in an effort to determine the state of the workflow. The state of any job that has been submitted for execution may be one of successfully completed, unsuccessfully completed, or still running. More detail of the evaluating operation 260 will be provided hereafter in the description of FIG. 3.

FIG. 3 is a flow chart depicting one embodiment of a workflow analysis method 300. As depicted, the workflow analysis method 300 includes determining (310) whether there are more jobs to analyze, evaluating (320) the state of a job in the workflow, determining (330) whether the job has completed successfully, determining (340) whether the job completed unsuccessfully, determining (350) whether the job is still running, indicating (360) a workflow state of still running, indicating (370) a workflow state of unsuccessful completion, and indicating (380) a workflow state of successful completion. The workflow analysis method 300 enables the analysis of all jobs included in a workflow, allowing for automatic determination of workflow completion.

Determining (310) whether there are more jobs to analyze may include cycling through the data structures of successor and predecessor jobs corresponding to the workflow to determine if any jobs are active (i.e., are in a running state). If there are more jobs remaining to analyze, the workflow analysis method 300 proceeds to the evaluate operation 320. Otherwise, if there are no more active jobs, the method proceeds by indicating (380) a successful completion state.

Evaluating (320) the state of a job in the workflow may include checking a status indicator of the current job. The current state of the job may include not submitted (i.e., unsatisfied dependencies), running, successful completion, or unsuccessful completion. In some embodiments, the data structures corresponding to the workflow contain a status indicator that identifies the current state of the job. A job may be considered to be inactive if the job has completed or the dependency requirements for the job have not been satisfied. A workflow may be determined to be no longer running if each of the jobs corresponding to the workflow is determined to be inactive.

Determining (330) whether a job has completed successfully may include checking the status indicator of the current job, within the data structures corresponding to the workflow, to determine the current state of the job. If the status indicator indicates that the job has completed successfully, the workflow analysis method 300 proceeds by determining (310) whether there are more jobs to analyze. Otherwise, the method proceeds by determining (340) whether a job completed unsuccessfully.

Determining (340) whether a job completed unsuccessfully may include checking the status indicator of the current job, within the data structures corresponding to the workflow, to determine the current state of the job. If the status indicator indicates that the job has completed unsuccessfully, the workflow analysis method 300 proceeds by indicating (370) an unsuccessful completion state. Otherwise, the method proceeds by determining (350) whether a job is still running.

Determining (350) whether a job is still running may include checking the status indicator of the current job, within the data structures corresponding to the workflow, to determine the current state of the job. If the status indicator indicates that the job is running, the workflow analysis method 300 proceeds by indicating (360) the job is still in a running state. Otherwise, the method loops to the determining (310) whether there are more jobs to analyze.

Indicating (360) a workflow state of running may include the monitoring application indicating the workflow is still running. In one embodiment, the workflow analysis method 300 continues analyzing jobs to assure none of the remaining jobs has completed unsuccessfully. In another embodiment, the monitoring application enters a wait state and resumes workflow analysis when a job finishes and the evaluate workflow 260 operation of FIG. 2 becomes active. In some embodiments, a GUI contains a status bar that indicates the workflow is still running. In other embodiments, a batch operation receives no response until the status changes to either successful completion or unsuccessful completion.

Indicating (370) a workflow state of unsuccessful completion may include ending the workflow monitoring application and returning an unsuccessful completion code. In some embodiments, the monitoring application ends and a GUI containing a status bar indicates the workflow has completed unsuccessfully. In other embodiments, the monitoring application ends and presents a message indicating unsuccessful completion of the workflow.

Indicating (380) a workflow state of successful completion may include ending the workflow monitoring application and returning a successful completion code. In some embodiments, the monitoring application ends and a GUI containing a status bar indicates the workflow has completed successfully. In other embodiments, the monitoring application ends and presents a message indicating successful completion of the workflow.

FIG. 4 is a block diagram depicting various components of one embodiment of a computer suitable for executing the methods disclosed herein, in accordance with an embodiment of the present invention. The computer 400 may be one embodiment of the data processor 110 depicted in FIG. 1. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 405, memory 406, persistent storage 408, communications unit 412, and input/output (I/O) interface(s) 415. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 416 and cache memory 418. In general, memory 406 can include any suitable volatile or non-volatile computer readable storage media.

One or more programs may be stored in persistent storage 408 for execution by one or more of the respective computer processors 405 via one or more memories of memory 406. The persistent storage 408 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 415 allows for input and output of data with other devices that may be connected to computer 400. For example, I/O interface 415 may provide a connection to external devices 420 such as a keyboard, keypad, a touch screen, and/or some other suitable input device. External devices 420 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 408 via I/O interface(s) 415. I/O interface(s) 415 also connect to a display 422. Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, executed by a computer, for accurately determining a workflow completion state, the method comprising:
initiating a workflow comprising one or more jobs;
receiving a notification that a first job, corresponding to the workflow, has finished;
checking dependency requirements of a successor job corresponding to the first job, and submitting the successor job for processing if the dependency requirements have been satisfied; and
evaluating a completion status of the one or more jobs to determine whether the workflow is still running.

2. The method of claim 1, wherein the workflow is determined to be no longer running if each of the one or more jobs is determined to be inactive.

3. The method of claim 2, wherein a job of the one or more jobs is determined to be inactive if the job has completed or the dependency requirements for the job have not been satisfied.

4. The method of claim 1, wherein the workflow is determined to be no longer running if any of the one or more jobs is determined to be completed unsuccessfully.

5. The method of claim 1, wherein the workflow is determined to be still running if any of the one or more jobs is running.

6. The method of claim 1, wherein a user is notified if the workflow is no longer running.

7. The method of claim 1, wherein business logic corresponding to the workflow prohibits a job of the one or more jobs from running.

8. The method of claim 1, wherein determining whether the workflow is still running occurs without requiring a user to provide completion criteria for the workflow.
